(19) United States
(12) Patent Application Publication
(10) Pub. No.: US 2022/0082996 A1
(43) Pub. Date: Mar. 17, 2022

(54) PHOTORECEPTOR TEMPERATURE CONTROL

(71) Applicant: Hewlett-Packard Development Company, L.P., Spring, TX (US)

(72) Inventors: Vitaly Portnoy, Ness Ziona (IL); Dmitry Maister, Ness Ziona (IL); Yossi Yaacobov, Ness Ziona (IL); Michel Assenheimer, Ness Ziona (IL); Brian Schmitz Tani, Porto Alegre (BR); Nailson Boaz Costa Leite, Porto Alegre (BR)

(73) Assignee: Hewlett-Packard Development Company, L.P., Spring, TX (US)

(21) Appl. No.: 17/417,191

(22) PCT Filed: May 31, 2019
(86) PCT No.: PCT/US2019/034996

§ 371 Date: Jun. 22, 2021

(51) Int. Cl. G03G 21/20; G03G 15/00

(52) U.S. Cl. CPC G03G 21/20; G03G 15/5045

(57) ABSTRACT

There is disclosed a device such as a printer or temperature control device for a printer. The device may comprise a photoreceptor. The device may further comprise a heat exchanger to regulate a temperature of the photoreceptor. The device may further comprise a temperature regulator to measure a temperature of a surface of the photoreceptor and control the heat exchanger based on the measured temperature. The device may further comprise a superior temperature controller to, during a pre-print phase of a print action, inhibit the control of the heat exchanger by the temperature regulator and control the heat exchanger to provide a specified amount of heat exchange.

### BACKGROUND

Electro-photography (EP) printing devices form images on media by selectively discharging a photoconductor in correspondence with the images. The selective discharging of the photoconductor forms a latent image on the photoconductor. Colorant is then developed onto the latent image of the photoconductor, and the colorant is ultimately transferred to the media to form the image on the media. In dry EP (DEP) printing devices, toner is used as the colorant, and it is received by the media as the media passes below the photoconductor. The toner is then fixed in place as it passes through heated pressure rollers. In liquid EP (LEP) printing devices, printing fluid (e.g. ink) is used as the colorant instead of toner. In LEP devices, a printing fluid (e.g. ink) image developed on the photoconductor is offset to an image transfer element, where it is heated until the solvent evaporates and the resinous colorants melt. This image layer is then transferred to the surface of the media in the form of an image or text. It should be understood that where the term “ink” is used in this application, the term “printing fluid” may be substituted.

### BRIEF DESCRIPTION OF DRAWINGS

Examples will now be described, by way of non-limiting example, with reference to the accompanying drawings, in which:

FIG. 1 is a simplified schematic of an example of an apparatus for providing temperature control of a photoreceptor;

FIG. 2 is a flowchart of an example of a method of controlling the temperature of a photoreceptor;

FIG. 3 is a flowchart of an example of a further method of controlling the temperature of a photoreceptor; and

FIG. 4 is a simplified schematic of an example of a further apparatus for providing temperature control of a photoreceptor.

### DETAILED DESCRIPTION

A liquid electro-photographic (LEP) printing device may be a digital offset press that uses electrically charged ink with a thermal offset print blanket. In an LEP printing press, the surface of a photo imaging component may be selectively discharged using photo-induced electric conductivity and a laser beam or LED illumination to form a latent image. The photo imaging component may be referred to as a “photoconductor” or a “photoreceptor”. Charged liquid ink may then be applied to the surface of the photoreceptor, forming an ink image. The charged ink may be attracted to locations on the photoreceptor where surface charge has been neutralized by the laser or LED, and rejected from locations on the photoreceptor where surface charge has not been neutralized by the laser or LED. The ink image may then be transferred from the surface of the photoreceptor to an intermediate transfer medium (ITM, referred to herein as the “blanket”, or “print blanket”). Transferring the ink image from the photoreceptor to the print blanket may be referred to as the “first transfer”. In a “second transfer,” the ink image may then be transferred from the print blanket to the print media (e.g., sheet paper, web paper) by pressing the media being held between the ITM and an impression drum against the blanket. During this printing process, the blanket may be heated and maintained at a high temperature in order to evaporate solvents present in the liquid ink and to partially melt and blend solid ink particles. The high blanket temperature may also facilitate the second transfer of the image onto the print media.

In order to maintain the photoreceptor at or near the correct temperature during printing, a feedback temperature control may be provided, in which the surface temperature of the photoreceptor may be measured and the surface of the photoreceptor may then be cooled based on the measured temperature.

Before printing begins, the photoreceptor may not be at the appropriate temperature. The temperature, when in operation, of coolant used to cool the photoreceptor may be lower than the ambient temperature (room temperature) and, when inactive, the temperature of the coolant may rise to the ambient temperature. Therefore, following a period of inactivity, the coolant may not provide optimal cooling to the photoreceptor. The temperature of the photoreceptor may, following start up, rise further if the surface thereof is in contact with other printer components having a higher temperature, such as the blanket. The time between either printer activation or receipt of printing instructions and start of printing may be relatively short (in some examples, approximately 30-40 s). In some examples, a start of a print action may be taken as the point at which a print instruction is received or a button pushed. Following the start of a print action, a printer may undergo a procedure including pre-print, print and post-print phases. In the pre-print phase, components of the printer may be activated in a specific order and preparatory actions may be taken to ready the printer for printing. The pre-print phase may be carried out before the print phase can begin and printing may be carried out during the print phase.

Printing may be carried out during the print phase and, in some examples, printing may begin at the start of the print phase. The pre-print phase may be started at the point that the print instruction is received or an initiating command executed. The pre-print phase may be completed before the print phase may begin. The pre-print phase may include actions which are dependent on other actions, meaning the pre-print phase may involve the actions being carried out in a specific order.

In some examples, one such action, to be carried out during the pre-print phase may be the activation of temperature control, such as cooling, for the photoconductor in the printer. A photoconductor may be heated through interaction with other components in the printer and cooled by a temperature control system. For example, a photoconductor, during printing, may contact the ITM which may be maintained at a higher temperature than the operating temperature of the photoconductor. At the interface between the photoconductor and the ITM therefore the temperature of the surface of the photoconductor may be locally raised above the operating temperature of the photoconductor. A temperature control system may be used to bring the temperature of the surface of the photoconductor back down.

During the pre-print phase, the printer components may not, initially, be at their respective operating temperatures. After a long period of inactivity, the printer components may all be at or near ambient temperature. Following the start of the pre-print phase, respective components of the printer may warm up at different rates. The photoconductor may have a temperature control system, including a heat exchanger and coolant, to cool the surface thereof. The temperature control system may be controlled by a closed-loop temperature control. For example, the surface temperature of the photoconductor may be measured and the closed-loop temperature control activated or a rate of cooling set accordingly. Closed-loop temperature control may however take some time to activate as there may be a delay in the temperature measurement and the transmission of the feedback signal. At the start of the pre-print phase, the signals used for closed-loop temperature control may not yet be available, either due to the system used or if coolant flow to the photoconductor has not yet commenced temperature measurements may in effect be meaningless. Therefore, in order to reduce the possibility of the photoconductor getting too hot, cooling in the pre-print phase may be improved.

In some examples, there is provided a method for performing photoreceptor temperature control in the pre-print phase. A feedback temperature control system may take time before cooling the photoreceptor sufficiently to reach the intended operating temperature range. In some examples, transitioning from the pre-print phase to the print phase may be carried out without the photoreceptor reaching the intended operating temperature range. In such examples, printing may start irrespective of the temperature of the photoreceptor and irrespective of whether the photoreceptor has reached the intended operating temperature range. In some examples therefore, a method for speeding up the cooling of the photoreceptor in the pre-print phase, prior to printing, is provided.

To modify the closed-loop cooling of the photoreceptor may involve compromising between achieving the correct amount of cooling when the printer is in a transient state (i.e. during start-up) and when the printer is in a steady state (i.e. during continuous printing). In order to improve the photoreceptor cooling during transient states, a superior or override temperature control, for example an open-loop temperature control, process may be provided, which may bypass or override the normal temperature control or simply supersede or inhibit the normal temperature control commands when activated, and instead instruct a cooling system to, during the pre-print phase of printing, provide optimal or maximal cooling to the surface of the photoreceptor.

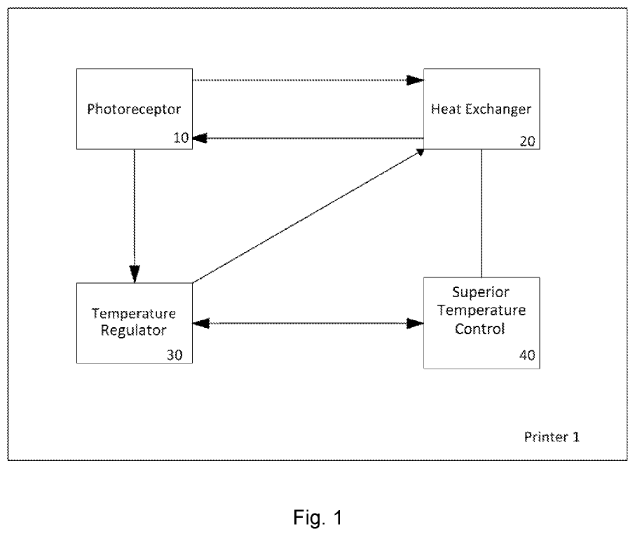

In some examples, as shown in FIG. 1, there is provided a device 1, which may be a printer or cooling device for a printer. The device 1 may comprise a photoreceptor 10. A photoreceptor 10 may also be referred to as a photoconductor. The device 1 may further comprise a heat exchanger 20. The heat exchanger 20 may regulate the temperature of the photoreceptor 10. The device 1 may further comprise a temperature regulator 30. The temperature regulator 30 may measure a temperature of a surface of the photoreceptor 10 and may further control the heat exchanger 20 based on the measured temperature. The device 1 may further comprise a superior temperature controller 40, for example a temperature controller which may inhibit, override or suppress the control from the temperature regulator 30. The superior temperature controller 40 may, during a pre-print phase of a print action, inhibit the control of the heat exchanger 20 by the temperature regulator 30 and may control the heat exchanger 20 to provide a specific, for example greater amount or rate of heat exchange. Control of the heat exchanger may be returned to the temperature regulator 30 before or when printing starts. For example, the superior temperature controller 40 may deactivate or stop temperature control during the pre-print phase or at least before the print phase starts, so that the temperature regulator 30 may provide steady-state temperature control during or over the print phase. Allowing the temperature regulator 30 to regulate the temperature of the surface of the photoreceptor 10 during the print phase may ensure consistently high-quality printing. Switching control to the superior temperature controller 40 during the pre-print phase may provide the benefit that the photoreceptor 10 may be prevented from overheating or locally overheating at locations where in contact with other warmer printer components. In some examples, the photoreceptor 10 and blanket may rotate so that the point of contact, where the heated blanket contacts the photoreceptor 10, moves across the photoreceptor 10 heating the entire surface, for example during rotation.

The temperature regulator 30 may include, or be connected to, a temperature sensor, for example an infrared (IR) temperature sensor which may detect the temperature of the surface of the photoreceptor 10. The superior temperature controller 40 may in some examples be referred to as an override unit or control overrider. The superior temperature controller 40 may for example block control of the heat exchanger 20 from the temperature regulator 30 and provide alternative temperature control instructions to the heat exchanger 20, which may increase the rate of heat exchange from the photoreceptor 10 to cool the photoreceptor 10 more quickly. In some examples, the superior temperature controller 40 may be an open-loop temperature control without feedback from the temperature of the photoreceptor 10.

The temperature regulator 30, which may control the heat exchanger 20, may be programmed or optimised to provide control of the temperature of the photoreceptor 10 during a steady state, for example during continuous printing. The superior temperature controller 40 may cause the heat exchanger 20 to cool the photoreceptor 10 faster than the temperature regulator 30. Therefore, the temperature control carried out by the superior temperature controller 40 may define a shorter time constant. The temperature regulator 30 may provide a feedback loop for controlling the temperature of the surface of the photoreceptor 10 based on a measured temperature of the surface of the photoreceptor 10. The superior temperature controller 40 may provide open-loop control for controlling the temperature of the surface of the photoreceptor 10 and may instruct, or control, the heat exchanger 20 to provide a maximum or optimal amount of heat exchange, or cooling, possible. This may be combined with ensuring the flow rate of coolant is set at the appropriate level for maximum cooling. Coolant may for example be oil, such as may be used as carrier fluid in liquid electrophotography (LEP) presses.

In some examples, the superior temperature controller 40 may override or block temperature control from the temperature regulator 30 when coolant flow is activated. Overriding the temperature regulator 30 when the coolant begins to flow may provide the benefit of ensuring appropriate heat exchange away from the photoreceptor 10, rather than a part of the coolant being cooled and remaining in the proximity of the heat exchanger 20.

In some examples, the superior temperature controller 40 may override the temperature regulator 30 when the device 1 is activated. In other examples, the superior temperature controller 40 may override the temperature regulator 30 when printing instructions are received by the device 1. It may be beneficial to begin the cooling of the photoreceptor 10 as early as possible, once it is determined that the photoreceptor 10 is to be used for a print job. Providing a superior temperature controller 40, as described, may allow for faster cooling of the photoreceptor 10, when compared with the feedback temperature control of the temperature regulator 30, as there is no delay in determining the current temperature of the photoreceptor 10 before cooling can begin.

In some examples, the superior temperature controller 40 may cancel the override and return control of the heat exchanger 20 to the temperature regulator 30 after a predetermined period of time or if specific conditions are met, for example if printing is started. If printing is not started until a time where the photoreceptor 10 is deemed to be at the correct temperature, temperature control may be returned to the temperature regulator 30. The predetermined period of time may for example be an amount of time taken to control the temperature of the coolant to bring the photoreceptor 10 to the intended operating temperature at the optimal cooling rate of the heat exchanger 20.

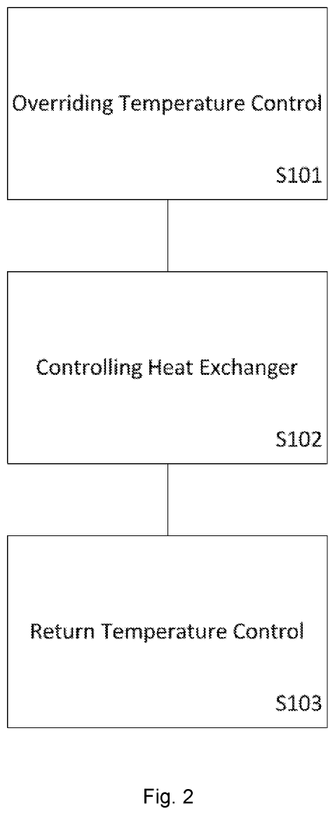

In some examples, as shown in FIG. 2, there is provided a method for cooling a photoreceptor. The method may comprise overriding S101 a closed-loop temperature control of a photoreceptor of a printer, during an activation phase of the printer. The activation phase may for example be part of the pre-print phase, described earlier, and may be after the start of a print action, but before printing begins. The method may further comprise controlling S102 a heat exchanger to cool the photoreceptor, while the closed-loop temperature control is overridden. The method may further comprise returning S103 temperature control of the photoreceptor to the closed-loop temperature control before printing starts.

A printer may be provided with temperature control to control the temperature of a photoreceptor, based on a measured temperature of the photoreceptor. The temperature control may be overridden to instead provide an open-loop control of the cooling of the photoreceptor. Open-loop control may allow a heat exchanger to provide an increased amount of heat exchange, or cooling. This may be continued for a specific period of time. In some examples, the open-loop control may be carried out in a pre-printing phase of a print job. In other words, when a printer receives a print job, a pre-print phase may be executed followed by a print phase. The pre-print phase may include various set up procedures including controlling the temperature of various printer components so that the correct temperature is reached before printing may begin in the print phase. The print phase may include the actual printing process.

In some examples, the overriding may be carried out when coolant flow is activated or when printing instructions are received by the printer. In some further examples the method may comprise cancelling the overriding after a predetermined period of time or when certain conditions are met, such as the temperature of the photoreceptor having reached the operating temperature or when temperature sensing becomes available.

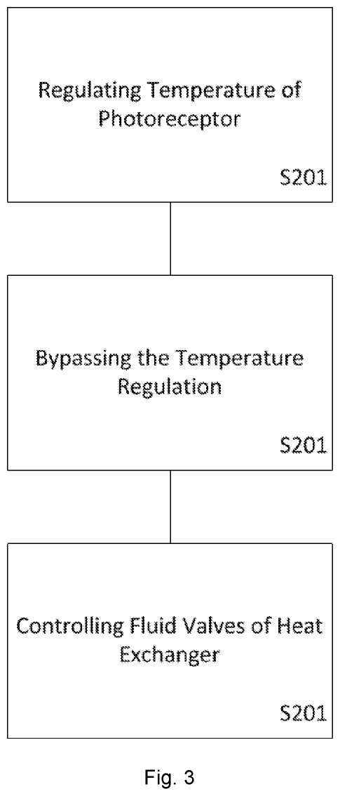

In some examples, as shown in FIG. 3, there is provided a further method for cooling a photoreceptor. The method may comprise regulating S201 the temperature of a photoreceptor of a printer, based on a measured temperature of a surface of the photoreceptor. The temperature regulation may be performed by a heat exchanger. The heat exchanger may have a number of cooling valves for controlling flow of cooling fluid through the heat exchanger. The method may further comprise bypassing S202 the temperature regulation during a period of time between activation of the printer and a start of printing. The method may further comprise controlling S203, during the period of time, the heat exchanger to increase the heat exchange from the photoreceptor, for example to cool the photoreceptor. During the period of time, the valves may be controlled, for example opened fully, to allow maximum/optimal heat exchange.

In some examples, the bypassing may be carried out when coolant flow is activated or when printing instructions are received by the printer. In some examples, the method may further comprise cancelling the bypassing after a predetermined period of time. In some examples, the bypassing may be carried out if the coolant temperature is above a threshold temperature, for example 15° C.

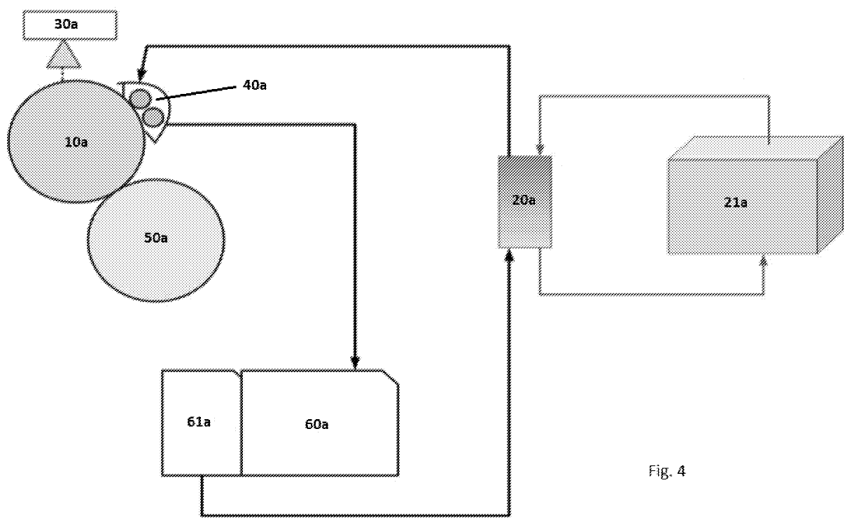

In some examples, as shown in FIG. 4, there is provided a cooling system for a photoreceptor 10a.

In some examples, photoreceptor 10a cooling may be achieved by surface wetting with coolant such as oil. Coolant may for example be a carrier fluid in Liquid Electro Photography (LEP) presses. A station 40a, which may for example be a cleaning station (CS) may be in contact with the photoreceptor 10a and may provide functions including: collecting ink remnants from the photoreceptor 10a after an image is transferred to the blanket around an intermediate transfer member 50a at a first transfer (T1). The cleaned photoreceptor 10a may then be used for writing and developing a new image in subsequent press rotation cycles. The station 40a may further provide photoreceptor cooling. Cooling may be carried out at a position after the photoreceptor 10a has contacted the heated blanket, based on the direction of movement of the various components. The photoreceptor 10a may undergo heating at T1 as the blanket is maintained at a higher temperature. The blanket and intermediate transfer member 50a may be maintained at around 110° C. for printing. However, for photoreceptor 10a operation the photoreceptor 10a surface may be at significantly lower temperature than the temperature after contact with the blanket at T1. This cooling may be achieved by contact with a controlled thin coolant film, metered from the station 40a. Coolant collected from the photoreceptor 10a surface by the station 40a may flow through a filter before continuing on to the heat exchanger 20a. In some examples, the coolant may flow through a “dirty” reservoir 60a before being passed through filters and into a “clean” reservoir 61a, before continuing on to the heat exchanger 20a (water-oil cooler), and then being returned to the station 40a. The heat exchanger 20a (HX) may be connected to a chiller 21a and controlled by a selected number of valves (open or closed) to allow different cooling levels. For example, the heat exchanger 20a may include three valves providing low, medium and high levels of heat exchange. In some examples continuous valves, such as metering valves may be provided.

When the printer is not printing and no printing instructions are received, the valves may be closed. When closed, there may be no flow and no cooling. With no cooling, the coolant temperature, inside the HX 20a for example, may rise to the temperature of the surrounding environment. This warming of the coolant may depend on how much time has passed since the last print. Even a short break of a few minutes between prints may results in the coolant temperature rising up to room temperature, for example 20° C.

With a feedback controlled cooling of the photoreceptor 10a, when a printing instruction is received, the valves may remain closed until the temperature regulator (not shown in FIG. 4) instructs otherwise, which may lead to a rise in the photoreceptor 10a temperature, at least until the valves are opened. This may take some time due to a delay in the measurement of the photoreceptor 10a temperature, by for example an infrared thermometer 30a, and instructions being sent to the heat exchanger 20a. Shortening this feedback time may not be possible. Therefore, under normal feedback temperature control alone, in some examples the photoreceptor 10a may be too hot until after printing has begun. This may affect print quality (for example, colour uniformity between start and end of printed image) and may contribute to a lower photoreceptor 10a lifespan.

In many printers, printing may be started for example when the blanket temperature is stable. At that time, the photoreceptor 10a temperature may not yet be stable, and may still be too high. In some printers, pre-print may start when the coolant temperature is too high. Normally, before printing begins the photoreceptor 10a will not come into contact with the blanket. Once the pre-print phase ends and the printer transitions into the print phase, the photoreceptor 10a temperature may rise rapidly due to contact with the hot blanket at T1 and/or due to the coolant temperature being still too high.

In some examples, by implementing the superior temperature controller 40 as described above, the coolant temperature may be brought down to an appropriate temperature much faster, meaning improved cooling of the photoreceptor 10a at the start of the print phase, and when in contact with the blanket, may be possible. According to some examples, the temperature of the photoreceptor 10a, which may otherwise not reach the intended operating temperature until 5-10 minutes into printing, may be lowered sooner.

In some examples, stable photoreceptor 10a temperature may be achieved during printing. Examples may provide benefits including more constant print quality during operation (from the first to the last page of a print job) and reduced influence of printing interruptions, as well as better photoreceptor lifespan performance. Longer photoreceptor 10a lifespan may provide longer consistent print quality, and also may improve press productivity by reducing operator intervention for replacing photoreceptors 10a. In some examples, stable photoreceptor temperature 10, 10a may be achieved during printing by tailoring the (open-loop) cooling during the pre-print phase.

In some examples, instead of performing a cooling function, in the examples described herein, heating may be performed. Temperature regulators and controllers may be programmed to perform temperature control including both heating and cooling.

In some examples, there is further provided a program which, when executed on a computer, causes the computer to carry out a process. The process may comprise overriding a closed-loop temperature control of a photoreceptor of a printer, during an activation phase of the printer. The process may further comprise controlling a heat exchanger to cool the photoreceptor. The process may further comprise returning temperature control of the photoreceptor to the closed-loop temperature control before or when printing starts.

In some examples, there is further provided a program which, when executed on a computer, causes the computer to carry out a process. The process may comprise regulating, by a heat exchanger, the temperature of a photoreceptor of a printer, based on a measured temperature of a surface of the photoreceptor. The heat exchanger may have a number of cooling fluid valves for controlling flow of cooling fluid through the heat exchanger. The process may further comprise bypassing the temperature regulation, during a period of time between activation of the printer and a start of printing. The process may further comprise controlling, during the period of time, the heat exchanger to increase a rate of heat exchange away from the photoreceptor.

In some examples, there is provided a non-transitory computer readable medium having stored thereon software instructions that, when executed by a processor, cause the processor to carry out the process described above.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and/or block diagrams of the methods, devices and systems according to examples of the present disclosure. Although the flow diagrams described above show a specific order of execution, the order of execution may differ from that which is depicted. Blocks described in relation to one flow chart may be combined with those of another flow chart.

It shall be understood that each flow and/or block in the flow charts and/or block diagrams, as well as combinations of the flows and/or diagrams in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus, functional modules of the apparatus and devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A device comprising:
a photoreceptor;
a heat exchanger to regulate a temperature of the photoreceptor;
a temperature regulator to measure a temperature of a surface of the photoreceptor and control the heat exchanger based on the measured temperature; and
a superior temperature controller to, during a pre-print phase of a print action, inhibit the control of the heat exchanger by the temperature regulator and control the heat exchanger to provide a specified amount of heat exchange.

2. The device of claim 1, wherein
the superior temperature controller is to override any active control of the heat exchanger by the temperature regulator.

3. The device of claim 1, wherein
the superior temperature controller is to control the heat exchanger when the device is activated or when printing instructions are received by the device.

4. The device of claim 1, wherein
the superior temperature controller is to control the heat exchanger for a predetermined period of time.

5. The device of claim 1, wherein
the superior temperature controller is to control the heat exchanger following receipt of printing instructions by a printer.

6. A method comprising:
overriding a closed-loop temperature control of a photoreceptor of a printer, during an activation phase of the printer;
controlling a heat exchanger to cool the photoreceptor; and
returning temperature control of the photoreceptor to the closed-loop temperature control before or when printing starts.

7. The method of claim 6, wherein
the overriding is carried out when coolant flow is activated.

8. The method of claim 6, further comprising:
cancelling the overriding after a predetermined period of time.

9. (canceled)

10. The program of claim 14, wherein
the bypassing is carried out when coolant flow is activated.

11. The program of claim 14, wherein
the bypassing is carried out when printing instructions are received by the printer.

12. The program of claim 14, further comprising:
cancelling the bypassing after a predetermined period of time.

13. (canceled)

14. A program which, when executed on a computer, causes the computer to carry out a process comprising:
regulating, by a heat exchanger, the temperature of a photoreceptor of a printer, based on a measured temperature of a surface of the photoreceptor;
bypassing the temperature regulation, during a period of time between activation of the printer and a start of printing; and
controlling, during the period of time, the heat exchanger to increase a rate of heat exchange away from the photoreceptor.

15. The program of claim 14, wherein
the bypassing is carried out when coolant flow is activated or printing instructions are received by the printer.
